(19) United States
(12) Patent Application Publication
(10) Pub. No.: US 2013/0120336 A1
(43) Pub. Date: May 16, 2013

(54) DISPLAY APPARATUS AND DRIVING METHOD THEREOF

(71) Applicants: Jung-min KU, Gumi-si (KR); Hyun-chul SONG, Suwon-si (KR)

(72) Inventors: Jung-min KU, Gumi-si (KR); Hyun-chul SONG, Suwon-si (KR)

(73) Assignee: SAMSUNG ELECTRONICS CO., LTD., Suwon-si (KR)

(21) Appl. No.: 13/606,736

(22) Filed: Sep. 7, 2012

(30) Foreign Application Priority Data
Nov. 15, 2011 (KR) 10-2011-0119075

(51) Int. Cl. G06F 3/038

(52) U.S. Cl. 345/211

(57) ABSTRACT

A display apparatus is provided. The display apparatus includes a display panel on which a plurality of X-Y electrode pairs are sequentially arranged, the display panel including a plurality of X electrodes and a plurality of Y electrodes; a driving unit which applies a driving voltage to the X electrodes and the Y electrodes; and a control unit which controls the driving unit to apply the driving voltage to a first electrode group including a number of X-Y electrode pairs that are isolated from one another and then to a second electrode group including a number of X-Y electrode pairs that are arranged among the X-Y electrode pairs included in the first electrode group.

### CROSS-REFERENCE TO RELATED APPLICATION(S)

This application claims priority under 35 U.S.C. §119 from Korean Patent Application No. 10-2011-0119075, filed on Nov. 15, 2011, in the Korean Intellectual Property Office, the disclosure of which is incorporated herein by reference in its entirety.

### BACKGROUND

1. Field

Apparatuses and methods consistent with the exemplary embodiments relate to a display apparatus and a driving method thereof, and more particularly, to a display apparatus using a plasma display panel (PDP) and a driving method of the display apparatus.

2. Description of the Related Art

Flat display apparatuses are generally used for portable devices and are rapidly replacing cathode ray tube (CRT) displays due to the development of large display technologies in the flat display field.

Plasma display panels (PDPs) are a type of flat display apparatus which display text or graphics using light emitted from plasma generated by gas discharge. Compared with other kinds of flat display apparatuses, PDPs have high luminance, a high efficiency of light emission, and a wide viewing angle, and are widely used today.

A typical PDP includes an X driving circuit, a Y driving circuit, and an address driving circuit. The X driving circuit is connected to X electrodes and drives the PDP by applying a voltage to the X electrodes. The Y driving circuit is connected to Y electrodes and drives the PDP by applying a voltage to the Y electrodes. The address driving circuit drives the PDP by applying a data signal to address electrodes.

The X driving circuit and the Y driving circuit perform a sustain discharge operation on a number of selected pixels by sequentially applying a sustain voltage to the X electrodes and the Y electrodes that are arranged among the X electrodes. In this example, however, noise may be generated throughout the top of the display panel due to a high-voltage/high-current sustain driving waveform.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a display apparatus capable of reducing sustain noise by controlling an electrode driving signal, which is applied to a plasma display panel (PDP), and a driving method of the display apparatus.

According to an aspect of the exemplary embodiments a display apparatus includes: a display panel on which a plurality of X-Y electrode pairs, including a plurality of X electrodes and a plurality of Y electrodes, are sequentially arranged; a driving unit which applies a driving voltage to the X electrodes and the Y electrodes; and a control unit which controls the driving unit to apply the driving voltage to a first electrode group including a number of X-Y electrode pairs that are isolated from one another and then to a second electrode group including a number of X-Y electrode pairs that are arranged among the X-Y electrode pairs included in the first electrode group.

The X-Y electrode pairs included in the first electrode group may be even-numbered X-Y electrode pairs and the X-Y electrode pairs included in the second electrode group may be odd-numbered X-Y electrode pairs.

The X-Y electrode pairs included in the first electrode group may be odd-numbered X-Y electrode pairs and the X-Y electrode pairs included in the second electrode group may be even-numbered X-Y electrode pairs.

The driving unit may include: an X electrode driving module which applies the driving voltage to the X electrodes; and a Y electrode driving module which applies the driving voltage to the Y electrodes.

The control unit may control the X electrode driving module to sequentially apply the driving voltage to the X electrodes included in the first electrode group and then to the X electrodes included in the second electrode group, and may control the Y electrode driving module to sequentially apply the driving voltage to the Y electrodes included in the first electrode group and then to the Y electrodes included in the second electrode group.

The X electrode driving module may include: a first X electrode driver which sequentially applies the driving voltage to the X electrodes included in the first electrode group; and a second X electrode driver which sequentially applies the driving voltage to the X electrodes included in the second electrode group.

The Y electrode driving module may include: a first Y electrode driver which sequentially applies the driving voltage to the Y electrodes included in the first electrode group; and a second Y electrode driver which sequentially applies the driving voltage to the Y electrodes included in the second electrode group.

According to another aspect of the exemplary embodiments, a driving method of a display apparatus includes a display panel on which a plurality of X-Y electrode pairs, including a plurality of X electrodes and a plurality of Y electrodes, are sequentially arranged, the driving method including: applying a driving voltage to a first electrode group including a number of X-Y electrode pairs that are isolated from one another; and applying the driving voltage to a second electrode group including a number of X-Y electrode pairs that are arranged among the X-Y electrode pairs included in the first electrode group.

The X-Y electrode pairs included in the first electrode group may be even-numbered X-Y electrode pairs and the X-Y electrode pairs included in the second electrode group may be odd-numbered X-Y electrode pairs.

The X-Y electrode pairs included in the first electrode group may be odd-numbered X-Y electrode pairs and the X-Y electrode pairs included in the second electrode group may be even-numbered X-Y electrode pairs.

The applying the driving voltage to the first electrode group may include sequentially applying the driving voltage to the X electrodes and the Y electrodes included in the first electrode group, and the applying the driving voltage to the second electrode group may include sequentially applying the driving voltage to the X electrodes and the Y electrodes included in the second electrode group.

As described above, it is possible to alternately drive a pair of adjacent X-Y electrode pairs by applying a driving voltage to a first electrode group including a number of X-Y electrode pairs that are isolated from one another and then to a second electrode group including a number of X-Y electrode pairs that are arranged among the X-Y electrode pairs included in the first electrode group. Therefore, it is possible to reduce noise radiated from electrodes.

### BRIEF DESCRIPTION OF THE DRAWINGS

The above and/or other aspects will be more apparent by describing certain exemplary embodiments with reference to the accompanying drawings, in which:

FIG. 1 is a side cross-sectional view illustrating a display apparatus according to an exemplary embodiment;

FIG. 2 is a partial perspective view illustrating an example of a display panel illustrated in FIG. 1, according to an exemplary embodiment;

FIG. 3 is a partial exploded perspective view illustrating an example of the display apparatus illustrated in FIG. 1, according to an exemplary embodiment;

FIG. 4 is a block diagram illustrating a display apparatus according to another aspect of an exemplary embodiment;

FIG. 5 is a diagram illustrating an example of the structure of the display apparatus illustrated in FIG. 4, according to an exemplary embodiment;

FIGS. 6A to 6C are diagrams illustrating a driving method of a display apparatus, according to an exemplary embodiment;

FIG. 7 is a diagram illustrating an example of the structure of a display apparatus according to an exemplary embodiment;

FIG. 8A is a diagram illustrating low-frequency radiation measurements obtained from a related-art display apparatus;

FIG. 8B is a diagram illustrating low-frequency radiation measurements obtained a display apparatus according to an exemplary embodiment; and

FIG. 9 is a flowchart illustrating a driving method of a display apparatus, according to an exemplary embodiment.

### DETAILED DESCRIPTION OF THE EXEMPLARY EMBODIMENTS

Certain exemplary embodiments will now be described in greater detail with reference to the accompanying drawings.

In the following description, the same drawing reference numerals are used for the same elements even in different drawings. The matters described in the description, such as detailed construction and elements, are provided to assist in a comprehensive understanding of the exemplary embodiments. Thus, it is apparent that the exemplary embodiments can be carried out without those specifically described matters. Also, well-known functions or constructions are not described in detail since they would obscure the exemplary embodiments with unnecessary detail.

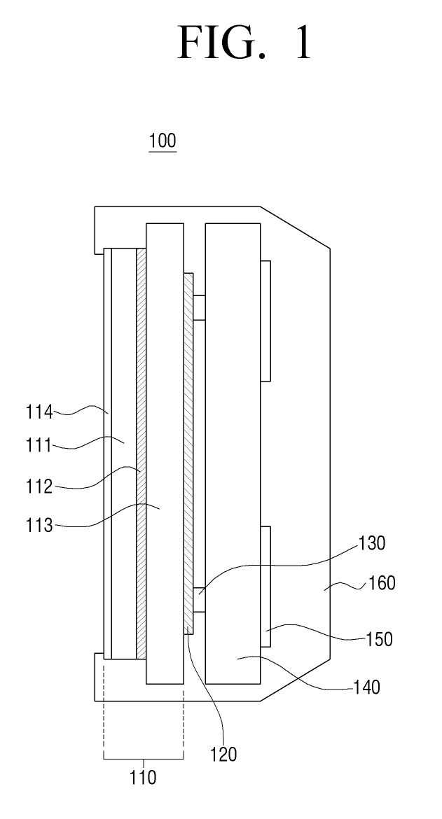

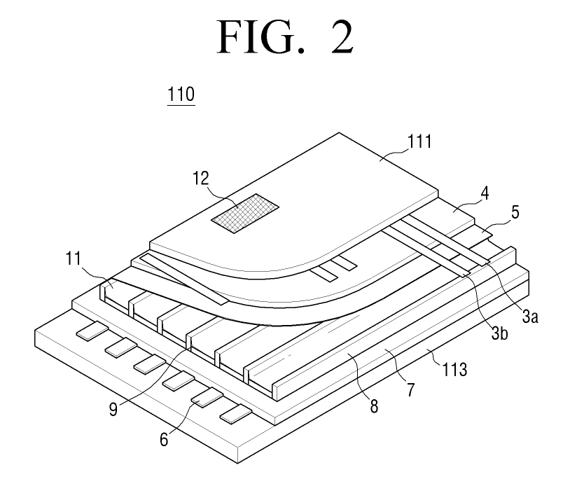

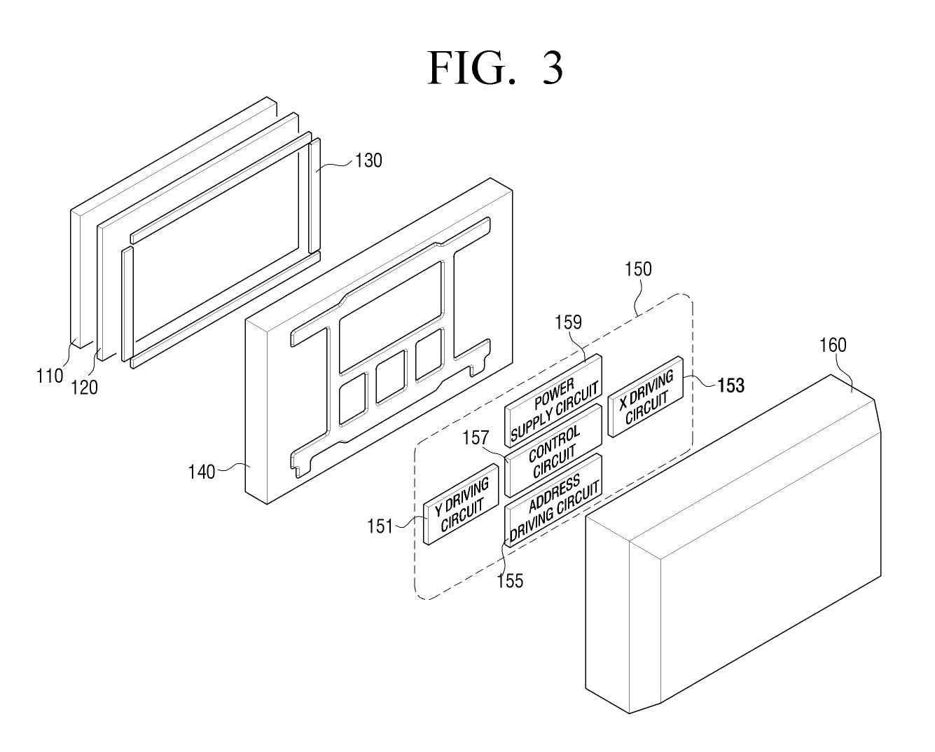

FIG. 1 is a side cross-sectional view illustrating a display apparatus according to an exemplary embodiment, FIG. 2 is a partial perspective view illustrating an example of a display panel illustrated in FIG. 1, according to an exemplary embodiment, and FIG. 3 is a partial exploded perspective view illustrating an example of the display apparatus illustrated in FIG. 1, according to an exemplary embodiment.

Referring to FIGS. 1 to 3, a display apparatus 100 may provide various images viewable to a user while satisfying requirements relating to electromagnetic interference (EMI). A display panel 110, which is included in the display apparatus 100, may be an alternating current (AC) plasma display panel (PDP).

The display apparatus 100 includes the display panel 110, a thermal spread sheet (TSS) 120, a gasket 130, a base chassis 140, a driving circuit 150, and a cover 160.

The display panel 110 may realize an image by exciting a fluorescent material with vacuum ultraviolet (UV) rays generated by an internal gas electric discharge. The display panel 110 includes an upper panel 111 and a lower panel 113. An edge of the upper panel 111 is connected to an edge of the lower panel 113 using a sealing substance 112 such as frit so as to form a single display panel 110.

A plurality of discharge cells may be formed in a space between the upper panel 111 and the lower panel 113 sealed by the sealing substance 112, and each of the discharge cells may be filled with neon (Ne) and xenon (Xe).

In each discharge cell, electrodes which are connected to the driving circuit 150 may be arranged. If the driving circuit 150 supplies a voltage to the electrodes, the display apparatus 100 may operate. A detailed description of a driving method of the display apparatus 100 according to an exemplary embodiment is given below.

A glass filter 114 may be attached or coated on an upper side of the upper panel 111 for surface reflection prevention, color correction, near infrared ray absorption, EMI blocking, etc. The glass filter 114 may be formed in a single filter layer or in a plurality of filter layers which differ from each other according to their function.

A filter layer for surface reflection prevention prevents a viewer from viewing glare and prevents scratches and static electricity on the surface. A filter layer for color correction and color purity improvement prevents light having a wavelength between 580 nm and 590 nm from being emitted to the viewer so as to enhance a color correction range and correct white deviation.

A filter layer for near infrared ray absorption prevents light having a wavelength between 800 nm and 1200 nm from being emitted to the viewer so as to prevent malfunctioning of the display apparatus 100 by interference with a wavelength band of a remote control. A filter layer for EMI blocking reduces EMI emitted toward the front surface of the panel 110.

The TSS 120 is attached onto a rear surface of the lower panel 113. The TSS 120 is used to dissipate the heat from the display apparatus 100 and thus to prevent deterioration of picture quality.

In addition, the TSS 120 is connected to the base chassis 140 through the gasket 130 so as to block EMI. That is, since energy of a driving wave causing discharge emits EMI using the electrodes on the display panel 110 as an antenna by the voltage and the current which are applied to the X electrodes and the Y electrodes, the TSS 120 may be connected to the base chassis 140 through the gasket 130 so as to reduce EMI emission.

The TSS 120 may be formed of foam graphite, which is a hybrid carbon material with pores and has a thermal conductivity of 240 W/mK or higher. For example, the TSS 120 may be formed of an E-Graf.

In this exemplary embodiment, the TSS 120 is used to dissipate the heat and block the EMI, but this is merely an example. Even when a sheet to dissipate the heat and a sheet to block the EMI are separately provided, technical aspects of the exemplary embodiments can be applied. Furthermore, if it is not necessary to dissipate the heat or if the heat can be dissipated by other methods, it is also possible to provide only a sheet to block the EMI.

In order to connect the TSS 120 with the base chassis 140, the gasket 130 may be formed of a bondable substance. In particular, in order to transmit the electric current from the TSS 120 to the base chassis 140, the gasket 130 is formed of a conductive material such as a metal fabric. That is, the gasket 130 may electrically connect the TSS 120 and the base chassis 140 so that the base chassis 140 can be used as the ground and the return path can be provided between the TSS 120 and the base chassis 140.

The base chassis 140 may accommodate the driving circuit 150, and may ground the electric current generated by the driving circuit 150.

Referring to FIG. 3, the driving circuit 150 may include a Y driving circuit 151, an X driving circuit 153, an address driving circuit 155, a control circuit 157, and a power supply circuit 159. The X driving circuit 153, the Y driving circuit 151, and the address driving circuit 155 may transmit an X electrode driving signal, a Y electrode driving signal, and an address electrode driving signal, respectively, to the X electrodes, the Y electrodes, and the address electrodes, respectively, so as to drive the display panel 110. Each of the X driving circuit 153, the Y driving circuit 151, and the address driving circuit 155 may be controlled by the control unit 157.

The driving circuit 150 may be disposed on a rear surface of the base chassis 140.

Referring to FIG. 2, a plurality of X electrodes 3a and a plurality of Y electrodes 3b may be formed in parallel with one another below the upper panel 111. The X electrodes 3a may be paired with the Y electrodes 3b, respectively. The X electrodes 3a and the Y electrodes 3b may be covered by a dielectric layer 4 and a passivation layer 5.

Barrier walls 8 may be formed on portions of an insulating layer 7 among a plurality of address electrodes 6. A fluorescent material 9 may be formed on the surface of the insulating layer 7 and on both side walls of each of the barrier walls 8.

The upper panel 111 and the lower panel 113 may face each other with discharge spaces 11 interposed therebetween, in such a manner that the X electrodes 3a and the Y electrodes 3b may intersect the address electrodes 6.

Discharge spaces 11 at the intersections between the X electrodes 3a and the address electrodes 6 and between the Y electrodes 3b and the address electrodes 6 may form discharge cells 12.

The term “wall charge” may indicate, but is not limited to, electric charge generated at the walls of a discharge cell (particularly, a dielectric layer of the discharge cell) near an electrode and accumulated in the electrode. Even though wall charge does not directly contact an electrode, wall charge may often be referred to as being “formed,” “deposited,” or “accumulated” in an electrode. The term “wall voltage” may indicate, but is not limited to, a potential difference formed in the walls of a discharge cell due to wall charge.

The barrier walls 8 may not only form the discharge spaces 11 but also shield light generated by a gas electric discharge, thereby preventing crosstalk. A matrix of a plurality of discharge cells 12 each discharge cell having the above-mentioned structure are formed on a substrate, and may be coated with a fluorescent material, thereby forming a PDP with a plurality of pixels. A typical PDP realizes a desired color by causing a discharge in each pixel and exciting the fluorescent material applied onto the inner side walls of each pixel with the aid of UV rays generated by the discharge.

Referring back to FIG. 1, the cover 160 may cover a portion of the front surface of the display panel 110, and the side and the rear surface of the display panel 110 so as to prevent damage to the display panel 110 and the driving circuit 150. The cover 160 may block EMI emitted from the back of the display apparatus 100, and may thus be formed of a conductive material.

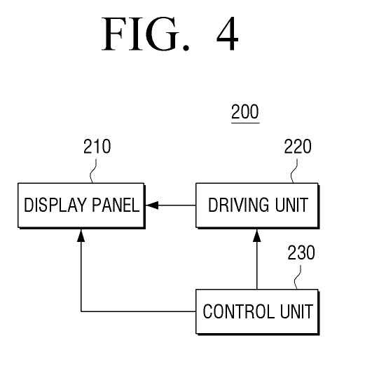

FIG. 4 is a block diagram illustrating a display apparatus according to an exemplary embodiment. Referring to FIG. 4, a display apparatus 200 includes a display panel 210, a driving unit 220, and a control unit 230. The display panel 210 and the driving circuit 220 are similar to their respective counterparts illustrated in FIGS. 1 to 3, and thus, detailed descriptions thereof will be omitted.

A plurality of X-Y electrode pairs including a plurality of X electrodes and a plurality of Y electrodes may be sequentially arranged in the display panel 210. For example, an X electrode and a Y electrode may be alternately arranged in the display panel 210, thereby forming the plurality of X-Y electrode pairs. A plurality of address electrodes may be arranged to intersect the X electrodes and the Y electrodes.

The driving unit 220 may apply a driving voltage to each of the X electrodes and the Y electrodes. For example, the driving unit 220 may apply an X electrode driving signal to the X electrodes and a Y electrode driving signal to the Y electrodes. The driving unit 220 may apply an address electrode driving signal to the address electrodes.

The driving unit 220 may include an X electrode driving module (not shown) for applying a driving voltage to the X electrodes, an Y electrode driving module (not shown) for applying a driving voltage to the Y electrodes, and an address electrode driving module (not shown) for applying a driving voltage to the address electrodes.

The control unit 230 may control the general operation of the display apparatus 100. The control unit 230 may control the driving unit 220 to apply a driving signal to the X electrodes, the Y electrodes, and the address electrodes.

For example, the control unit 230 may control the driving unit 220 to apply a driving voltage to a first electrode group including a number of X-Y electrode pairs that are isolated from one another and then to apply a driving voltage to a second electrode group including a number of X-Y electrode pairs that are arranged among the X-Y electrode pairs included in the first electrode group.

The X-Y electrode pairs included in the first electrode group may be even-numbered X-Y electrode pairs, and the X-Y electrode pairs included in the second electrode group may be odd-numbered X-Y electrode pairs.

Alternatively, the X-Y electrode pairs included in the first electrode group may be odd-numbered X-Y electrode pairs, and the X-Y electrode pairs included in the second electrode group may be even-numbered X-Y electrode pairs.

The control unit 230 may control the driving unit 220 to sequentially apply a driving voltage to the X electrodes and the Y electrodes.

For example, the control unit 230 may control the X electrode driving module to sequentially apply a driving voltage to a number of X electrodes included in the first electrode group and then to a number of X electrodes included in the second electrode group, and may control the Y electrode driving module to sequentially apply a driving voltage to a number of Y electrodes included in the first electrode group and then to a number of Y electrodes included in the second electrode group.

The X electrode driving module may include a first X electrode driver (not shown) which sequentially applies a driving voltage to the X electrodes included in the first electrode group and a second X electrode driver which sequentially applies a driving voltage to the X electrodes included in the second electrode group.

Similarly, the Y electrode driving module may include a first Y electrode driver (not shown) which sequentially applies a driving voltage to the Y electrodes included in the first electrode group and a second Y electrode driver which sequentially applies a driving voltage to the Y electrodes included in the second electrode group.

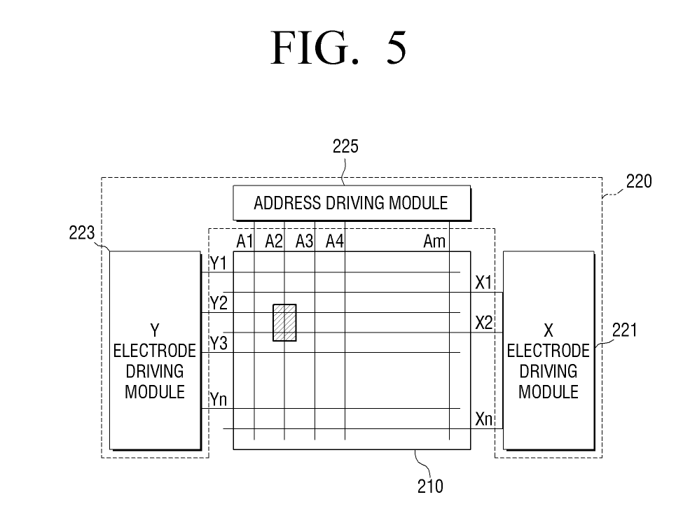

FIG. 5 is a diagram illustrating an example of the structure of the display apparatus 200 illustrated in FIG. 4, according to an exemplary embodiment. For convenience, the control unit 230 illustrated in FIG. 4 is not illustrated in FIG. 5, and a X electrode driving module 221, a Y electrode driving module 223, and an address electrode driving module 225 are illustrated in FIG. 5 as being located on the left side, on the right side, and at the top, respectively, of the display panel 210.

Referring to FIG. 5, the display panel 210 may have an n×m electrode matrix structure. A plurality of m address electrodes A₁ to Aₘ may be arranged in a column direction, and a plurality of n X-Y electrode pairs, including n X electrodes X₁ to Xₙ and n Y electrodes Y₁ to Yₙ, may be arranged in a row direction. That is, the X electrodes X₁ to Xₙ may be sequentially arranged, and the Y electrodes Y₁ to Yₙ may be sequentially arranged among the X electrodes X₁ to Xₙ in the order of X₁-Y₁, X₂-Y₂, . . . , Xₙ-Yₙ.

The display panel 210 may have a matrix of a plurality of pixels, and an X electrode, a Y electrode, and an address electrode may be formed on each of the pixels.

The display panel 210 may be operated in an address display separate (ADS) driving method in which each subfield is divided into a reset period, an address period, and a sustain discharge period.

In the ADS driving method, a frame may be divided into a plurality of subfields, and each subfield may be divided into a reset period, an address period, and a sustain discharge period. The reset period and the address period may be set to be identical for all subfields, and the sustain discharge period may be set to differ from one subfield to another subfield through the application of different weights. For example, according to the ADS driving method, the grayscale level of video data may be represented with a combination of one or more sustain discharge periods for sustaining a gas discharge.

The reset period of each subfield may be a period for erasing a previous wall charge state and setting up wall charges for stably performing a subsequent address discharge. The address period of each subfield may be a period for selecting a number of cells to be turned on or off and accumulating wall charges in the selected ‘on’ cells (i.e., addressed cells). The sustain discharge period may be a period for actually displaying an image with the use of the addressed cells by applying a sustain voltage alternately to the X electrodes X₁ to Xₙ and the Y electrodes Y₁ to Yₙ.

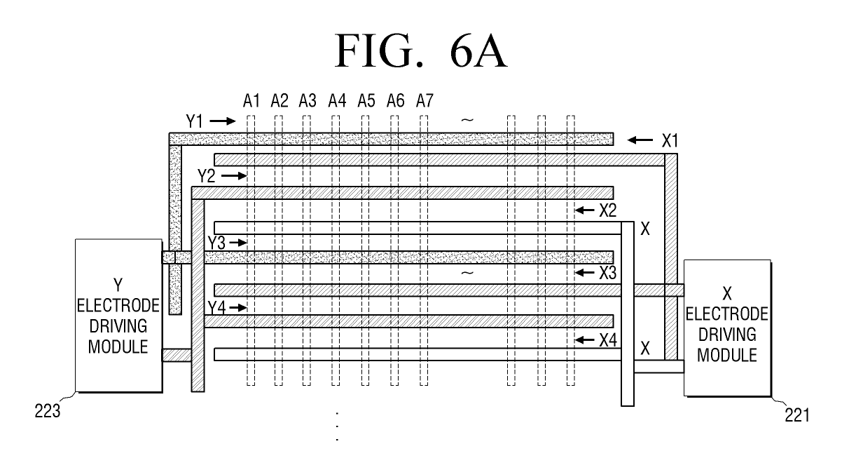

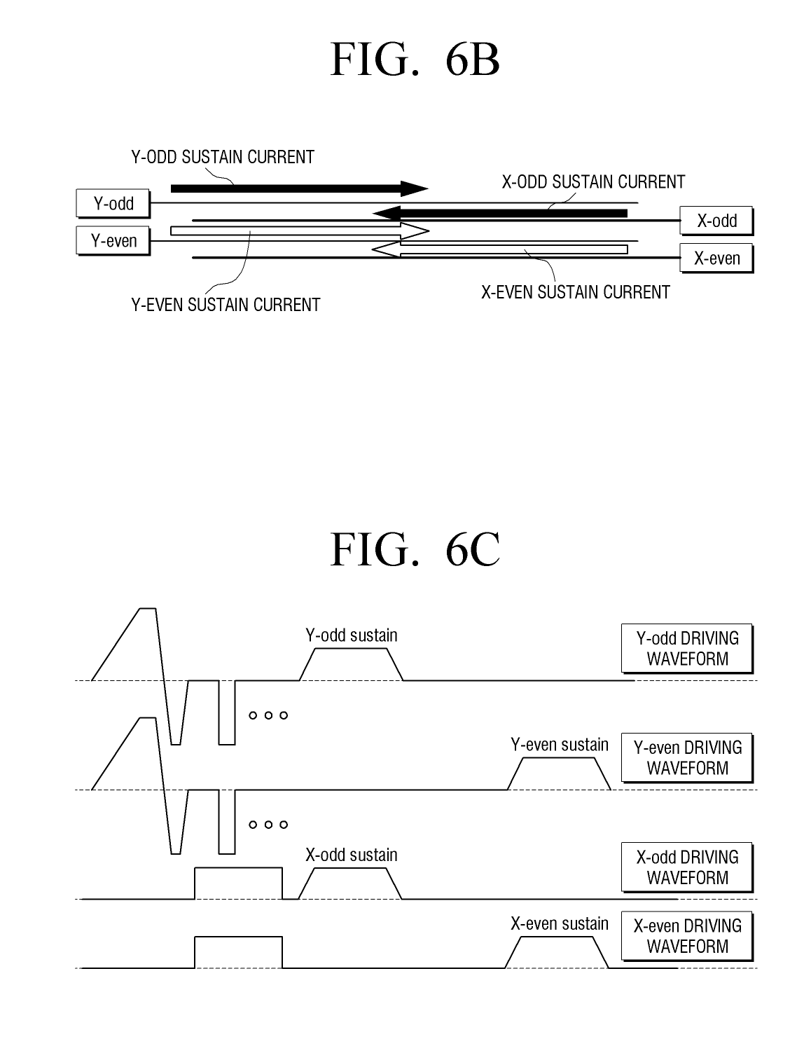

The X electrode driving module 221 may be connected to the X electrodes X₁ to Xₙ, and may apply a driving voltage to the X electrodes X₁ to Xₙ. The Y electrode driving module 223 may be connected to the Y electrodes Y₁ to Yₙ, and may apply a driving voltage to the Y electrodes Y₁ to Yₙ. In this manner, the display panel 210 may be driven. The X electrode driving module 221 and the Y electrode driving module 223 may sequentially apply a sustain voltage to the X electrodes and the Y electrodes included in a first electrode group and the X electrodes and the Y electrodes included in a second electrode group, thereby performing a sustain discharge for one or more selected pixels, which will be described later in detail with reference to FIGS. 6A to 6C.

The address electrode driving module 225 may apply a data signal for selecting one or more pixels to be displayed to the address electrodes A₁ to Aₘ.

The X electrodes X₁ to Xₙ and the Y electrodes Y₁ to Yₙ may perpendicularly intersect the address electrodes A₁ to Aₘ. The X electrodes X₁ to Xₙ may face the Y electrodes Y₁ to Yₙ, respectively, with discharge spaces interposed therebetween. The discharge spaces at the intersections between the X electrodes X₁ to Xₙ and the address electrodes A₁ to Aₘ and between the Y electrodes Y₁ to Yₙ and the address electrodes A₁ to Aₘ may form discharge cells.

FIGS. 6A to 6C are diagrams illustrating a driving method of a display apparatus, according to an exemplary embodiment. FIG. 6A illustrates the X electrode driving module 221, the Y electrode driving module 223, and the display panel 210 illustrated in FIG. 5. For convenience, the address electrode driving module 225 is not illustrated in FIG. 5, and the X electrode driving module 221 and the Y electrode driving module 223 are illustrated as being located on the right and left sides, respectively, of the display panel 210.

Referring to FIG. 6A, even-numbered X electrodes X₂, X₄, . . . , Xₙ (where n is an even number) may be connected to one another, and odd-numbered X electrodes X₁, X₃, . . . , Xₙ₋₁ may be connected to one another. Similarly, even-numbered Y electrodes Y₂, Y₄, . . . Yₙ may be connected to one another, and odd-numbered Y electrodes Y₁, Y₃, . . . , Yₙ₋₁ may be connected to one another.

The X electrode driving module 221 and the Y electrode driving module 223 may apply a driving voltage to a first electrode group including a plurality of X-Y electrode pairs that are isolated from one another, and then to a second electrode group including a plurality of X-Y electrode pairs that are arranged among the X-Y electrode pairs included in the first electrode group.

The operations of the X electrode driving module 221 and the Y electrode driving module 223 in a case in which the first electrode group includes even-numbered X-Y electrode pairs are as follows.

The X electrode driving module 221 may apply a sustain voltage to the even-numbered X electrodes X₂, X₄, . . . , Xₙ (where n is an even number), and the Y electrode driving module 223 may apply a sustain voltage to the even-numbered Y electrodes Y₂, Y₄, . . . , Yₙ. In this manner, it is possible to perform a sustain discharge operation on a number of selected pixels. For example, the X electrode driving module 221 may sequentially apply a driving voltage to the even-numbered X electrodes X₂, X₄, . . . , Xₙ, and the Y electrode driving module 223 may sequentially apply a driving voltage to the even-numbered Y electrodes Y₂, Y₄, . . . , Yₙ.

Thereafter, the X electrode driving module 221 may apply a sustain voltage to the odd-numbered X electrodes X₁, X₃, . . . , Xₙ₋₁, and the Y electrode may apply a sustain voltage to the odd-numbered Y electrodes Y₁, Y₃, . . . , Yₙ₋₁. In this manner, it is possible to perform a sustain discharge operation on a number of selected pixels. For example, the X electrode driving module 221 may sequentially apply a driving voltage to the odd-numbered X electrodes X₁, X₃, . . . , Xₙ₋₁, and the Y electrode driving module 223 may sequentially apply a driving voltage to the odd-numbered Y electrodes Y₁, Y₃, . . . , Yₙ₋₁.

In short, in a case in which the first electrode group includes the even-numbered X-Y electrode pairs, a sustain voltage may be applied to the even-numbered X-Y electrode pairs and then to the odd-numbered X-Y electrode pairs.

The operations of the X electrode driving module 221 and the Y electrode driving module 223 in a case in which the first electrode group includes the odd-numbered X-Y electrode pairs are as follows.

The X electrode driving module 221 may apply a sustain voltage to the odd-numbered X electrodes X₁, X₃, . . . , Xₙ₋₁, and the Y electrode driving module 223 may apply a sustain voltage to the odd-numbered Y electrodes Y₁, Y₃, . . . , Yₙ₋₁. In this manner, it is possible to perform a sustain discharge operation on a number of selected pixels. For example, the X electrode driving module 221 may sequentially apply a driving voltage to the odd-numbered X electrodes X₁, X₃, . . . , Xₙ₋₁, and the Y electrode driving module 223 may sequentially apply a driving voltage to the odd-numbered Y electrodes Y₁, Y₃, . . . , Yₙ₋₁.

Thereafter, the X electrode driving module 221 may apply a sustain voltage to the even-numbered X electrodes X₂, X₄, . . . , Xₙ, and the Y electrode may apply a sustain voltage to the even-numbered Y electrodes Y₂, Y₄, . . . , Yₙ. In this manner, it is possible to perform a sustain discharge operation on a number of selected pixels. For example, the X electrode driving module 221 may sequentially apply a driving voltage to the even-numbered X electrodes X₂, X₄, . . . , Xₙ, and the Y electrode driving module 223 may sequentially apply a driving voltage to the even-numbered Y electrodes Y₂, Y₄, . . . , Yₙ.

In short, in a case in which the first electrode group includes the odd-numbered X-Y electrode pairs, a sustain voltage may be applied to the odd-numbered X-Y electrode pairs and then to the even-numbered X-Y electrode pairs.

That is, a driving voltage may be applied to the even-numbered X-Y electrode pairs and then to the odd-numbered X-Y electrode pairs or may be applied to the odd-numbered X-Y electrode pairs and then to the even-numbered X-Y electrode pairs. Accordingly, it is possible to alternately drive a pair of adjacent X-Y electrode pairs and thus to generate current flows in opposite directions between the pair of adjacent X-Y electrode pairs. Therefore, it is possible to reduce radiated noise.

FIGS. 6B and 6C are diagrams illustrating a driving method of the display apparatus illustrated in FIG. 6A, according to an exemplary embodiment. More specifically, FIG. 6B illustrates an example of directions of the flows of sustain currents in a case in which the odd-numbered X-Y electrode pairs are driven prior to the even-numbered X-Y electrode pairs, and FIG. 6C illustrates an example of the waveforms of driving voltages in a case in which the odd-numbered X-Y electrode pairs are driven prior to the even-numbered X-Y electrode pairs.

Referring to FIG. 6B, in response to the application of a sustain voltage to the odd-numbered X-Y electrode pairs, sustain currents may be generated in directions indicated by black arrows. Thereafter, in response to the application of a sustain voltage to the even-numbered X-Y electrode pairs, sustain currents may be generated in directions indicated by white arrows. Accordingly, current flows in opposite directions may be generated between a pair of adjacent X-Y electrode pairs, thereby reducing radiated noise.

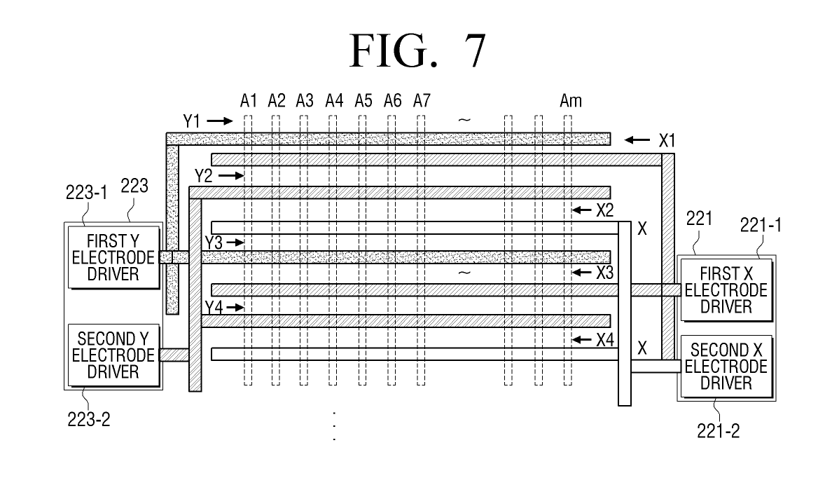

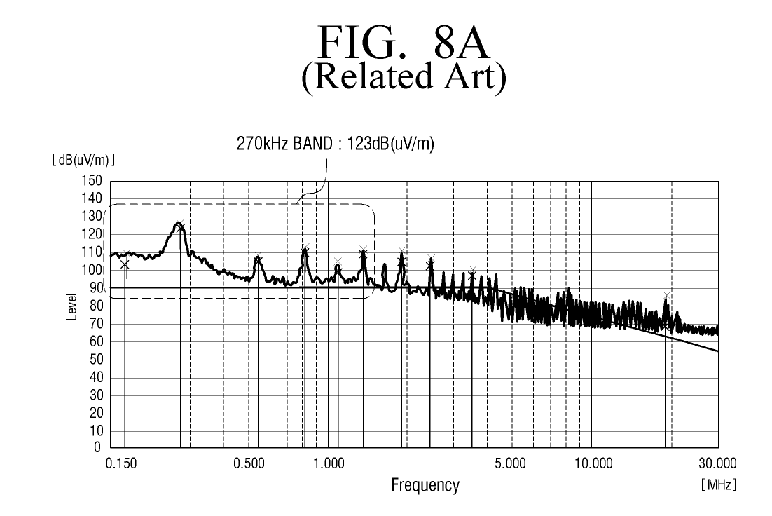

FIG. 7 is a diagram illustrating an example of the structure of a display apparatus according to an exemplary embodiment. The display apparatus illustrated in FIG. 7 is the same as the display apparatus illustrated in FIG. 6A except that an X electrode driving module 221 includes a first X electrode driver 221-1 for driving odd-numbered X electrodes and a second X electrode driver 221-2 for driving even-numbered X electrodes, and that a Y electrode driving module 223 includes a first Y electrode driver 223-1 for driving odd-numbered Y electrodes and a second Y electrode driver 223-2 for driving even-numbered Y electrodes.

That is, each of the X electrode driving module 221 and the Y electrode driving module 223 may include separate drivers for driving even-numbered X-Y electrode pairs and for driving odd-numbered X-Y electrode pairs.

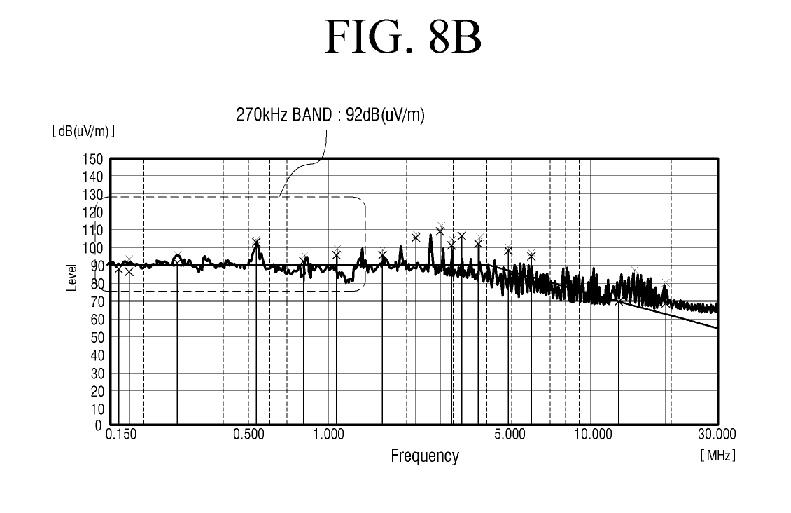

FIGS. 8A and 8B are diagrams illustrating low-frequency radiation measurements obtained from a related-art display apparatus and a display apparatus according to an exemplary embodiment. More specifically, FIG. 8A illustrates simulation results obtained by using a related-art display apparatus driving method in which a sustain voltage is sequentially applied to a plurality of X electrodes and a plurality of Y electrodes that are arranged among the X electrodes, and FIG. 8B illustrates simulation results obtained by using a driving method of a display apparatus, according to an exemplary embodiment, in which a sustain voltage is applied to odd-numbered X-Y electrode pairs and then to even-numbered X-Y electrode pairs or vice versa.

Referring to FIGS. 8A and 8B, according to the related art, a low-frequency radiation level of 123 dB(uV/m) is detected at a frequency band of 270 kHz, whereas, according to the present inventive concept, a low-frequency radiation level of 92 dB(uV/m) is detected at a frequency band of 270 kHz. That is, according to the present inventive concept, it is possible to reduce the level of frequency radiation.

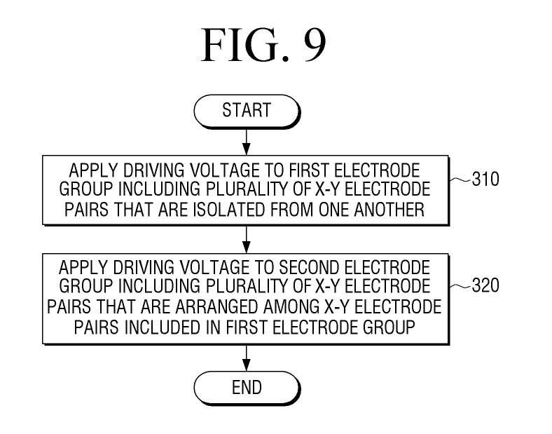

FIG. 9 is a flowchart illustrating a driving method of a display device, according to an exemplary embodiment. Referring to FIG. 9, a display apparatus according to an exemplary embodiment includes a display panel in which a plurality of X-Y electrode pairs, including a plurality of X electrodes and a plurality of Y electrodes, are sequentially arranged.

In operation S310, a driving voltage may be applied to a first electrode group including a number of X-Y electrode pairs that are isolated from one another.

For example, the first electrode group may include even-numbered X-Y electrode pairs. Alternatively, the first electrode group may include odd-numbered X-Y electrode pairs.

In operation S320, a driving voltage may be applied to a second electrode group including a number of X-Y electrode pairs that are arranged among the X-Y electrode pairs included in the first electrode group.

For example, the second electrode group may include the odd-numbered X-Y electrode pairs. Alternatively, the second electrode group may include the even-numbered X-Y electrode pairs.

In operation S310, a driving voltage may be sequentially applied to the X electrodes and the Y electrodes included in the first electrode group. In operation S320, a driving voltage may be sequentially applied to the X electrodes and the Y electrodes included in the second electrode group.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display panel comprising a plurality of X-Y electrode pairs which are sequentially arranged, wherein the plurality of X-Y electrode pairs comprise a plurality of X electrodes and a plurality of Y electrodes;
a driving unit which applies a driving voltage to the X electrodes and the Y electrodes; and
a control unit which controls the driving unit to apply the driving voltage to a first electrode group comprising a number of X-Y electrode pairs that are isolated from one another and then to a second electrode group comprising a number of X-Y electrode pairs that are arranged among the X-Y electrode pairs included in the first electrode group.

2. The display apparatus of claim 1, wherein the X-Y electrode pairs included in the first electrode group are even-numbered X-Y electrode pairs and the X-Y electrode pairs included in the second electrode group are odd-numbered X-Y electrode pairs.

3. The display apparatus of claim 1, wherein the X-Y electrode pairs included in the first electrode group are odd-numbered X-Y electrode pairs and the X-Y electrode pairs included in the second electrode group are even-numbered X-Y electrode pairs.

4. The display apparatus of claim 1, wherein the driving unit comprises:
an X electrode driving module which applies the driving voltage to the X electrodes; and
a Y electrode driving module which applies the driving voltage to the Y electrodes.

5. The display apparatus of claim 4, wherein the control unit controls the X electrode driving module to sequentially apply the driving voltage to the X electrodes included in the first electrode group and then to the X electrodes included in the second electrode group, and controls the Y electrode driving module to sequentially apply the driving voltage to the Y electrodes included in the first electrode group and then to the Y electrodes included in the second electrode group.

6. The display apparatus of claim 4, wherein the X electrode driving module comprises:
a first X electrode driver which sequentially applies the driving voltage to the X electrodes included in the first electrode group; and
a second X electrode driver which sequentially applies the driving voltage to the X electrodes included in the second electrode group.

7. The display apparatus of claim 4, wherein the Y electrode driving module comprises:
a first Y electrode driver which sequentially applies the driving voltage to the Y electrodes included in the first electrode group; and
a second Y electrode driver which sequentially applies the driving voltage to the Y electrodes included in the second electrode group.

8. A driving method of a display apparatus including a display panel on which a plurality of X-Y electrode pairs, including a plurality of X electrodes and a plurality of Y electrodes, are sequentially arranged, the driving method comprising:
applying a driving voltage to a first electrode group including a number of X-Y electrode pairs that are isolated from one another; and
applying the driving voltage to a second electrode group including a number of X-Y electrode pairs that are arranged among the X-Y electrode pairs included in the first electrode group.

9. The driving method of claim 8, wherein the X-Y electrode pairs included in the first electrode group are even-numbered X-Y electrode pairs and the X-Y electrode pairs included in the second electrode group are odd-numbered X-Y electrode pairs.

10. The driving method of claim 8, wherein the X-Y electrode pairs included in the first electrode group are odd-numbered X-Y electrode pairs and the X-Y electrode pairs included in the second electrode group are even-numbered X-Y electrode pairs.

11. The driving method of claim 8, wherein the applying the driving voltage to the first electrode group comprises sequentially applying the driving voltage to the X electrodes and the Y electrodes included in the first electrode group, and the applying the driving voltage to the second electrode group comprises sequentially applying the driving voltage to the X electrodes and the Y electrodes included in the second electrode group.

12. A display apparatus comprising:
a control unit comprising a processor which controls a driving unit to alternately apply a driving voltage to a first electrode group comprising a plurality of X-Y electrode pairs of a display panel and a second electrode group comprising a plurality of X-Y electrode pairs of the display panel not included in the first electrode group,
wherein the plurality of X-Y electrode pairs of the display panel in the first electrode group are not adjacent to one another.

13. The display apparatus of claim 12, wherein the first electrode group comprises even-numbered X-Y electrode pairs of the display panel and the second electrode group comprises odd-numbered X-Y electrode pairs of the display panel; or
wherein the first electrode group comprises odd-numbered X-Y electrode pairs of the display panel and the second electrode group comprises even-numbered X-Y electrode pairs of the display panel.

14. The display apparatus of claim 12, wherein the driving unit comprises:
an X electrode driving module which applies the driving voltage to the X electrodes of the plurality of X-Y electrode pairs of the display panel; and
a Y electrode driving module which applies the driving voltage to the Y electrodes of the plurality of X-Y electrode pairs of the display panel.

15. The display apparatus of claim 14, wherein the X electrode driving module comprises:
a first X electrode driver which sequentially applies the driving voltage to the X electrodes of the plurality of X-Y electrode pairs of the display panel included in the first electrode group; and
a second X electrode driver which sequentially applies the driving voltage to the X electrodes of the plurality of X-Y electrode pairs of the display panel included in the second electrode group.

16. The display apparatus of claim 14, wherein the Y electrode driving module comprises:
a first Y electrode driver which sequentially applies the driving voltage to the Y electrodes of the plurality of X-Y electrode pairs of the display panel included in the first electrode group; and
a second Y electrode driver which sequentially applies the driving voltage to the Y electrodes of the plurality of X-Y electrode pairs of the display panel included in the second electrode group.
